(19) United States
(12) Patent Application Publication
(10) Pub. No.: US 2016/0162991 A1
(43) Pub. Date: Jun. 9, 2016

(54) SYSTEM FOR ACCESSING AND CERTIFYING DATA IN A CLIENT SERVER ENVIRONMENT

(71) Applicant: HARTFORD FIRE INSURANCE COMPANY, Hartford, CT (US)

(72) Inventors: Kenneth R. DOIRON, Manchester, CT (US); Carmen MELARAGNO, Vernon, CT (US); Susan M. FRANKLIN, Bartlett, NH (US); Mark W. Whitsitt, Amston, CT (US)

(73) Assignee: HARTFORD FIRE INSURANCE COMPANY, Hartford, CT (US)

(21) Appl. No.: 14/561,032

(22) Filed: Dec. 4, 2014

(51) Int. Cl. G06Q 40/06; G06F 3/0482; G06F 3/0484; G06F 17/30

(52) U.S. Cl. CPC G06Q 40/06; G06F 17/30554; G06F 17/30528; G06F 3/0482; G06F 3/0484

(57) ABSTRACT

This invention relates to a database system in a distributed client server network environment for matching entity data with structured query data to validate selection of one or more entities for funding. Recertification of the entity may be electronically performed on a periodic basis to validate the entity.

### BACKGROUND

Financial data for various investment options, products and offerings is extremely difficult to manage, in part, due to the vast amount of data available. Especially difficult to manage is data related to hedge funds as much of this data is difficult to obtain and access. A hedge fund is an investment vehicle that pools capital from a number of investors and invests in securities and other instruments. Generally, a hedge fund is administered by a professional management firm, and often structured as a limited partnership, limited liability company, or similar entity. Typically, hedge funds invest in a diverse range of markets and use a wide variety of investment styles and financial instruments. Hedge funds are generally made available to certain sophisticated or accredited investors and entities and not offered or sold to the general public. As such, hedge funds generally avoid direct regulatory oversight, bypass licensing requirements applicable to investment companies, and operate with greater flexibility than mutual funds and other investment funds.

Because hedge funds are not sold to the general public or retail investors, hedge funds and their managers have historically been exempt from some of the regulation that governs other funds and investment managers with regard to how the fund may be structured and how strategies and techniques are employed. It would be desirable to have an automated, efficient and accurate system for evaluating, monitoring and tracking hedge fund performance and compliance. There is also a need for a system and process that address the needs of fund managers and investors seeking to select and validate one or more hedge funds.

### SUMMARY

The present invention is directed, in some embodiments, to a database system in a distributed network environment for matching prospect data with structured query data. The system includes a communications interface, a memory coupled to the communications interface, the memory configured to store an electronic query processing application, and a processor in communication with the memory, the processor being configured to execute the electronic query processing application stored in the memory, the electronic query processing application comprising program instructions for: compiling an electronic document containing structured queries for one or more fund entities; communicating the structured queries to the one or more fund entities; receiving data in response to the structured queries from the one or more fund entities; augmenting a content of the electronic document with the received data; parsing the electronic document in view of a plurality of baseline data; informing one or more trade instructions based on the parsed data; revalidating the received data on a periodic basis with the one or more fund entities; and displaying a graphical user interface of the received data.

In some embodiments, the present invention relates to a database system in a distributed network environment for matching fund prospect data with structured query diligence data. The system includes a memory configured to store an electronic query processing application, and a processor in communication with the memory, the processor being configured to execute the electronic query processing application stored in the memory, the electronic query processing application comprising program instructions for: compiling an electronic document containing structured queries for one or more fund entities; communicating the structured queries to the one or more fund entities; receiving data in response to the structured queries from the one or more fund entities; augmenting a content of the electronic document with the received data; parsing the electronic document in view of a plurality of baseline data; compiling one or more trade instructions based on the parsed data; informing one or more trade instructions based on the parsed data; and revalidating the received data on a periodic basis with the one or more fund entities, wherein revalidating comprises a verification of one or more of the received data.

In some embodiments, the present invention relates to a computer implemented method of operating a computer system to process fund and compliance data. The computer implemented method includes compiling an electronic document containing structured queries for one or more fund entities; communicating the structured queries to the one or more fund entities; receiving data in response to the structured queries from the one or more fund entities; augmenting a content of the electronic document with the received data; parsing the electronic document in view of a plurality of baseline data; compiling one or more trade instructions based on the parsed data; informing one or more trade instructions based on the parsed data; and revalidating the received data on a periodic basis with the one or more fund entities, wherein revalidating comprises a verification of one or more of the received data.

### BRIEF DESCRIPTION OF THE DRAWINGS

A more detailed understanding may be had from the following description, given by way of example, in conjunction with the accompanying drawings wherein:

FIG. 1 shows an exemplary system architecture that may be used to access and certify data in a client server environment;

FIG. 2 shows an exemplary system that may be used to access and certify data in a client server environment;

FIG. 3 shows another exemplary hedge fund data processing architecture;

FIG. 4 illustrates a method of auditing a hedge fund entity within the architecture of FIG. 3;

FIG. 5 illustrates a method utilized to conduct operations and a business risk management review within the architecture of FIG. 3;

FIG. 6 illustrates a method utilized to review the fund entity's reporting and transparency within the architecture of FIG. 3;

FIG. 7 illustrates a method for reviewing the fund entity's legal structure within the architecture of FIG. 3;

FIG. 8 illustrates a method for reviewing the fund entity's investment process within the architecture of FIG. 3;

FIG. 9 illustrates a method for reviewing fund compliance within the architecture of FIG. 3;

FIG. 10 illustrates a method for reviewing third party services associated with one or more funds within the architecture of FIG. 3;

FIG. 11 illustrates a method for reviewing a fund's general organization within the architecture of FIG. 3;

FIG. 12 illustrates a method for reviewing a fund's valuation policy within the architecture of FIG. 3;

FIG. 13 illustrates a method utilized to perform a review approval and subscription for one or more selected funds within the architecture of FIG. 3;

FIG. 14 shows an exemplary tabular representation of a portion of a hedge fund database record within the architecture of FIG. 1;

FIG. 15 shows a graphical user interface of an embodiment of the present invention; and

FIG. 16 illustrates a system including a user device for enabling and accessing a hedge fund management system interface for the review and administration of hedge fund data.

### DETAILED DESCRIPTION

Disclosed herein are processor-executable methods, computing systems, and related technologies for achieving efficiencies in connection with hedge fund related data processing, and particularly processing and analyzing hedge funds for investment, operational and compliance purposes. Administration of hedge fund data involves complicated and data intensive computer processing, including maintaining and updating records concerning hundreds of millions of dollars. This data is critical to both select a hedge fund for investment, such as by a corporate entity looking to invest, as well for monitoring performance, operations and compliance of such entities with company prescribed guidelines and policies, such as various business and legal guidelines and policies. Since hedge funds are free from many regulations that cover traditional investment vehicles, proper selection and monitoring of such hedge funds is critical. Computer-implemented solutions that simplify data processing associated with hedge funds are desired. The present system addresses complexities of data processing associated with hedge fund repayment computer systems by efficiently providing for data computer systems that consolidate and validate hedge fund performance and compliance data.

The present invention provides significant technical improvements to investment data processing technology. The present invention is directed to more than merely a computer implementation of a routine or conventional activity previously known in the industry as it significantly advances the technical efficiency, access and/or accuracy of investment data processing by implementing a specific new method and system as defined herein. The present invention includes systems and methods to implement interactions of types not previously known in the art between specialized computer systems. The present invention is a specific advancement in the area of investment data processing by providing technical benefits in data accuracy, data availability and data integrity, as well as benefits in efficiency in using data processing, storage and processing resources, and such advances are not merely a longstanding commercial practice. The present invention provides improvement beyond a mere generic computer implementation as it involves the processing and conversion of significant amounts of data in a new beneficial manner as well as the interaction of a variety of specialized investment, client and/or vendor systems, networks and subsystems.

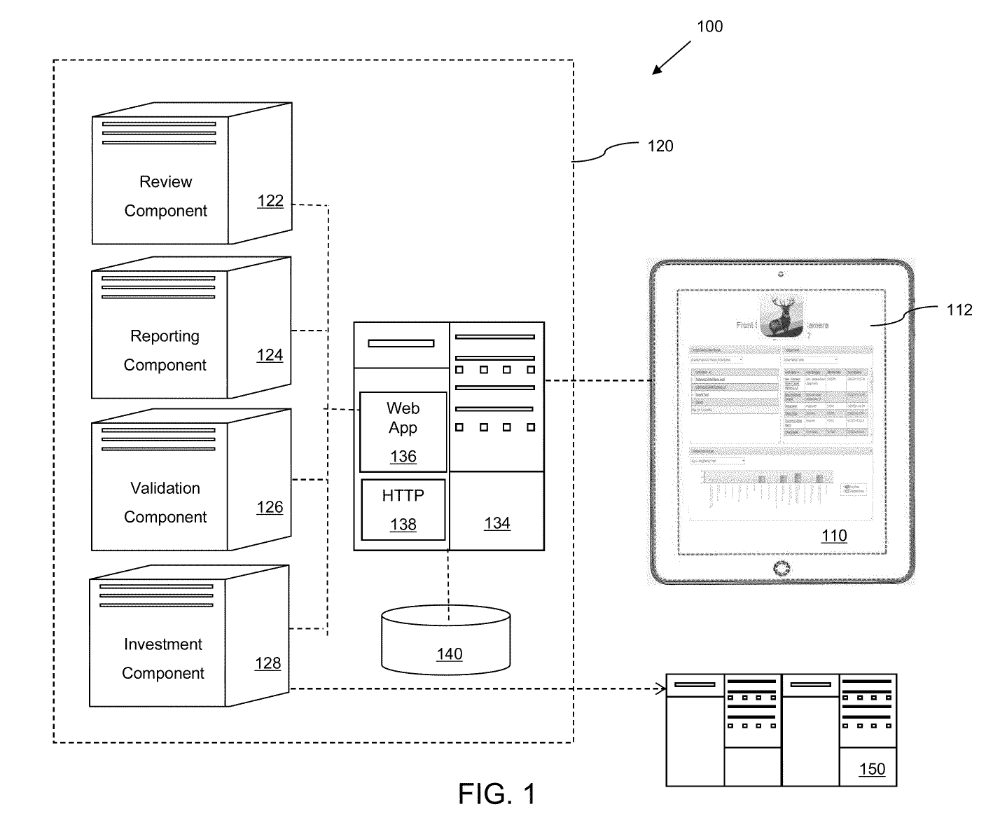

Features of some embodiments will now be described by referring to FIG. 1 which illustrates a system architecture 100 within which some embodiments may be implemented. More particularly, FIG. 1 depicts a system architecture 100 in which hedge fund data may be accessed and managed. Although the devices of architecture 100 are depicted as communicating via dedicated connections, it should be understood that the illustrated devices may communicate to one or more other illustrated devices through any number of other public and/or private networks, including but not limited to the Internet. Two or more of the illustrated devices may be located remote from one another and may communicate via any known manner of network(s) and/or a dedicated connection. Moreover, each device may comprise any number of hardware and/or software elements suitable to provide the functions described herein as well as any other functions. Other topologies may be used in conjunction with other embodiments.

According to the example architecture shown in FIG. 1, one or more requestor devices 110 are provided which comprise devices that may be operated by a user such as an investment professional or insurance company employee. Requestor device 110 may interact with an enterprise system 120 that may include a review component 122, a reporting component 124, a validation component 126, and an investment component 128, an application user interface running on web server 134. Web pages 112 provided by Web server 134 may request, update and access investment data related to one or more hedge funds. Web server 134 may include a web application module 136 and a HyperText Transfer Protocol (HTTP) server module 138. Web application module 136 may generate web pages 112 that make up the web site and that are communicated by HTTP server module 138. Web application module 136 may be implemented in and/or based on a technology such as Active Server Pages (ASP), PHP, Hypertext Preprocessor (PHP), Python/Zope, Ruby, any server-side scripting language, and/or any other appropriate technology.

HTTP server module 138 may implement the HTTP protocol, and may communicate HyperText Markup Language (HTML) pages and related data from web site 112 to/from client devices 110 using HTTP. HTTP server module 138 may be, for example, a Sun-ONE Web Server, an Apache HTTP server, a Microsoft Internet Information Services (IIS) server, and/or may be based on any other appropriate HTTP server technology. System 100 may also include one or more additional components or module, such as one or more switches, load balancers, firewall devices, routers, and devices that handle power backup and data redundancy (not shown).

Any number of requestor devices 110 may be employed to receive customer and insurance requests, and provide and access data. Requestor devices 110 may include, but are not limited to, cellular telephones, handheld wireless communication devices, personal digital assistants, pagers, laptop computers, tablet computers, smartphones, other mobile display devices, glasses based computing devices, or combinations thereof.

Requestor devices 110 may be in communication via a Web server 134 or other front end interface that allows remote terminals to send and receive data to the insurance company via system 100. The request data are received via the Web server 134 and are stored by data warehouse 140 for later action, such as an insurance workflow action or process. Any number or type of data storage systems may store the data in any suitable manner. Non-exhaustive examples of data storage systems include a relational database system, a spreadsheet, and any other data structure that is amenable to parsing and manipulating data. Data warehouse 140 may be managed by one or more database management systems which may be based on a technology such as Microsoft SQL Server, MySQL, Oracle Relational Database Management System (RDBMS), PostgreSQL, a NoSQL database technology, and/or any other appropriate technology.

Referring again to system 100 of FIG. 1, each of the components 122, 124, 126, 128 and the enterprise system 120 may comprise any combination of hardware, software and/or processor-executable instructions stored on a non-transitory, tangible medium. According to some embodiments, one or more of the components 122, 124, 126 or 128 may be a component of the data warehouse 140 or the enterprise system 120.

In some embodiments, enterprise system 120 may include an insurance workflow computer. An insurance workflow computer system may be configured to receive data indicative of the electronic communication issued to the requestor terminal, and to determine one or more insurance-related workflow modifications in response to receipt of the data indicative of the electronic communication. Insurance-related workflow modifications may include informing, which may include executing, trades, initiating validation of a hedge fund, requesting more information from the fund, adding or withdrawing funds that may be performed via one or third party servers 150.

It should be noted that embodiments are not limited to the devices illustrated in FIG. 1. Each device may include any number of disparate hardware and/or software elements, some of which may be located remotely from one another. Functions attributed to one device may be performed by one or more other devices. The devices of system 100 may communicate with one another (and with other non-illustrated elements) over any suitable communication media and protocols that are or become known.

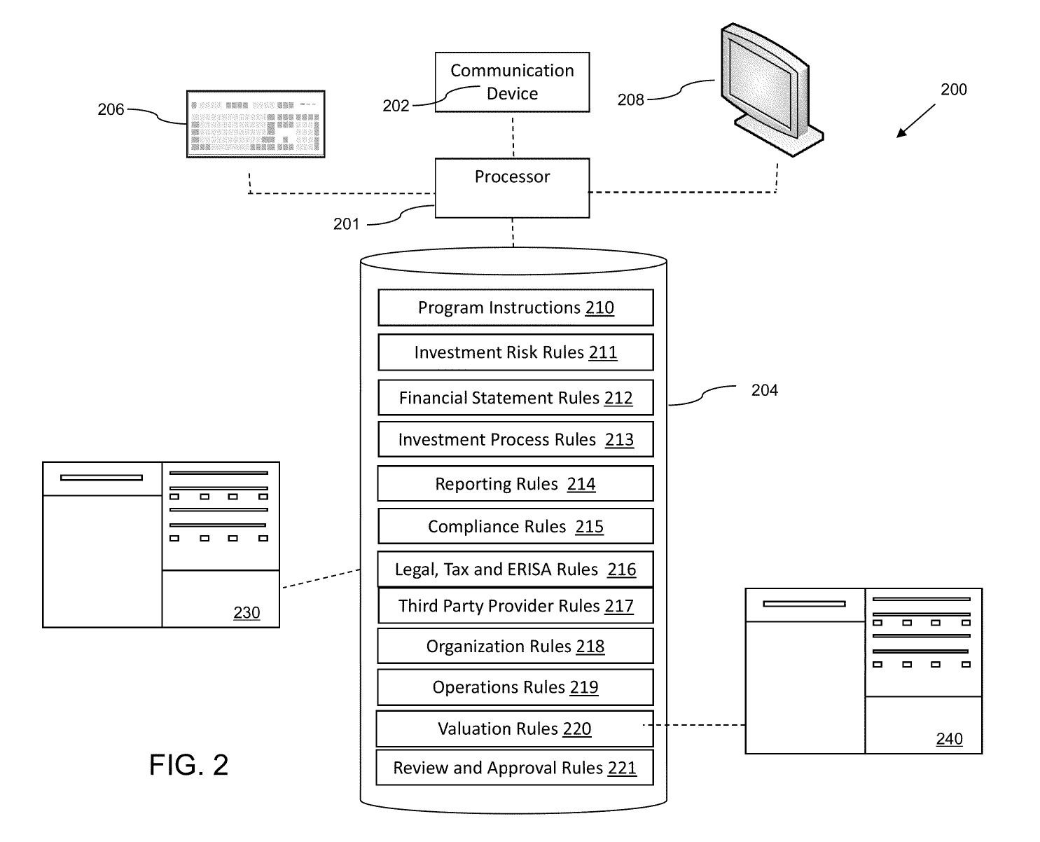

FIG. 2 is a block diagram of a computer system 200 utilized in the present invention according to some embodiments. Computer system 200 may perform the functions attributed to system 120 of FIG. 1. Computer system 200 includes processor 201 operatively coupled to communication device 202, data storage device 204, one or more input devices 206 and one or more output devices 208. Communication device 202 may facilitate communication with external devices. Input device 206 may comprise, for example, a keyboard, a keypad, a mouse or other pointing device, a microphone, knob or a switch, an infra-red (IR) port, a docking station, and/or a touch screen. Input device 206 may be used, for example, to enter information into computer system 200. Output device 208 may comprise, for example, a display (e.g., a display screen) a speaker, and/or a printer.

Data storage device 204 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices. Data storage device 204 stores program instructions 210 for execution by processor 201. Program instructions 210 may be executed by processor 201 to cause system 200 to operate as described. This operation may initially include operation of communication device 202 to retrieve hedge fund diligence and investment rules and criteria including, for example, investment risk rules 211, financial statement rules 212, investment process rules 213, reporting rules 214, compliance rules 215, legal/tax/ERISA rules 216, third party provider rules 217, organization rules 218, operations rules 219, valuation rules 220 and review and approval rules 221. In some embodiments, and as described with respect to FIG. 1, data storage device 204 may comprise a data warehouse, or network or cloud type storage facility or mechanism that is in communication with one or more third party database servers 230 and 240, such as servers or databases affiliated or connected to one or more hedge fund entities.

One or more public cloud, private cloud, hybrid cloud and cloud-like networks may also be implemented, for example, to store, handle and conduct processing of one or more transactions or processing of embodiments of the present invention. Cloud based computing may be used herein to handle any one or more of the application, storage and connectivity requirements of embodiments of the present invention. For example one or more private clouds may be implemented to handle hedge fund data of embodiments of the present invention. Furthermore, any suitable data and communication protocols may be employed to accomplish the teachings of embodiments of the present invention.

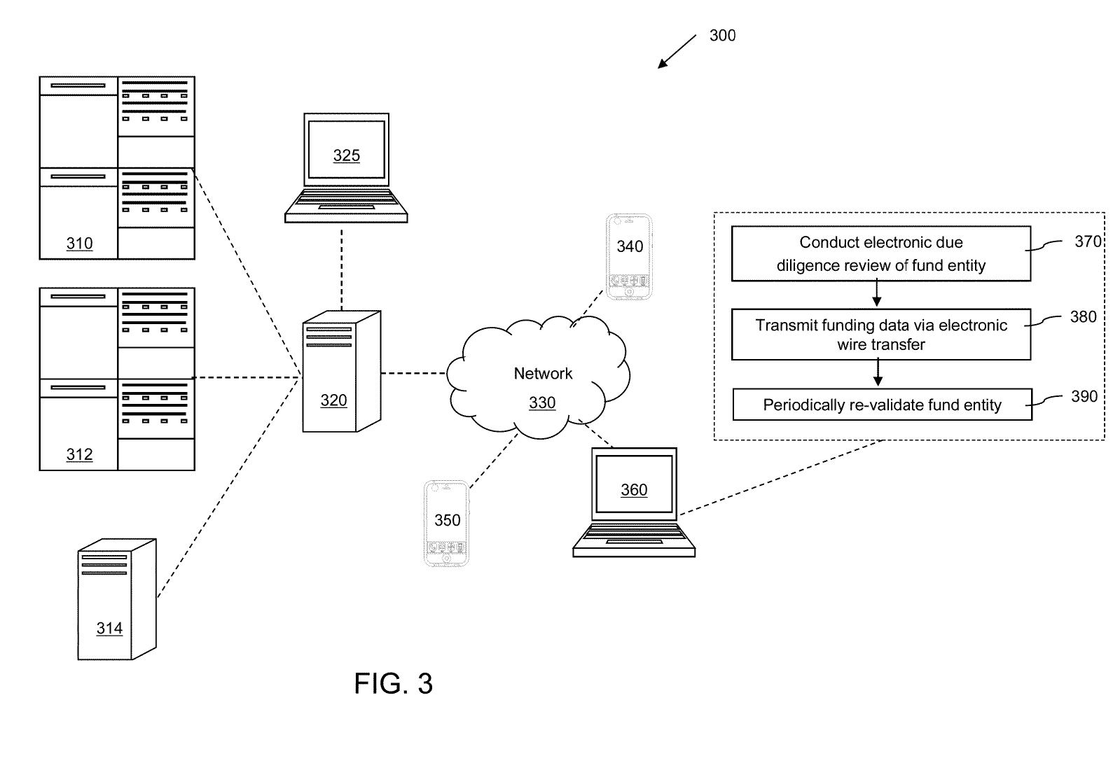

Referring now to FIG. 3, an exemplary hedge fund data processing architecture 300 is shown. Although some devices of architecture 300 are depicted as communicating via dedicated connections, it should be understood that all illustrated devices may communicate to one or more other illustrated devices through any number of other public and/or private networks, including but not limited to the Internet. Two or more of the illustrated devices may be located remote from one another and may communicate via any known manner of network(s) and/or a dedicated connection. Moreover, each device may comprise any number of hardware and/or software elements suitable to provide the functions described herein. Other topologies may be used in conjunction with other embodiments.

According to the example of FIG. 3, data servers 310, 312, 314 store hedge fund information associated with one or more third party hedge funds. Each of servers 310, 312, 314 may comprise any combination of hardware and/or software, including but not limited to relational databases, application servers, and spreadsheets. One or more of hedge fund data servers 310, 312, 314 may comprise an independent third party system, a data warehouse or any other aggregator of hedge fund information.

Each of servers 310, 312, 314 may provide hedge fund information to server 320 asynchronously or according to any schedule. In some embodiments, one or more of hedge fund data servers 310, 312, 314 provides a daily feed of hedge fund data to server 320. The hedge fund data of the feed may be associated with new insurance policies for which an initial premium has been paid or renewal policies for which additional premium are due.

Server 320 may comprise any combination of hardware and software to perform processes as described herein. According to some embodiments, when an insured party submits a claim or request for information about a hedge fund, server 320 receives hedge fund information associated with a hedge fund from one of sources 310, 312, 314 and processes the claim or other request. In general, when a request is received involving a hedge fund stored in one of the servers 310, 312, 314, the data is retrieved and returned to server 320 for processing.

Server 320 may comprise program instructions of a database management system, database procedures and/or database applications to process the data stored at those systems or retrieved by those systems. One or more administrator terminals or devices 325 may be in communication with server 320 and configured to provide display screens representing data stored in server 320 and options to permit an operator to edit this data and to otherwise provide commands to server 320. For example, an administrator terminal or device 325 may be configured to permit an operator to input commands via a user interface to update a data structure including information associated with a hedge fund or the like. Terminal or device 325 may comprise any suitable device including one or more input devices, such as keyboards, touchscreens and pointing devices, and display devices such as display screens, including but not limited to a desktop computer, tablet computer, and/or smartphone.

Data management server 320 may receive hedge fund records and associated hedge fund identifiers from servers 310, 312, 314. All terminals described herein may comprise any suitable devices for requesting and displaying user interfaces, including but not limited to desktop computers, cellular telephones, personal digital assistants, and laptops.

The insurance system 300 of FIG. 3 may provide other administration and maintenance features associated with policies issued pursuant to embodiments of the present invention. For example, a system server 320 may operate to receive and process change or update requests and may generate an interface or display screens to allow faster and easier data access.

Server 320 may also include a third party interface to control communications between third party servers 310, 312, 314. For example, a third party interface may facilitate communication to secure third party data related to a hedge fund. Server 320 may be accessible via a network 330 by devices 340, 350 and 360 to transmit, access and provide hedge fund related data. For example, device 360 may be utilized to conduct a due diligence review of one or more fund entities 370; to transmit funding data via an electronic wire transfer facility 380; and periodically re-validate the one or more fund entities 390.

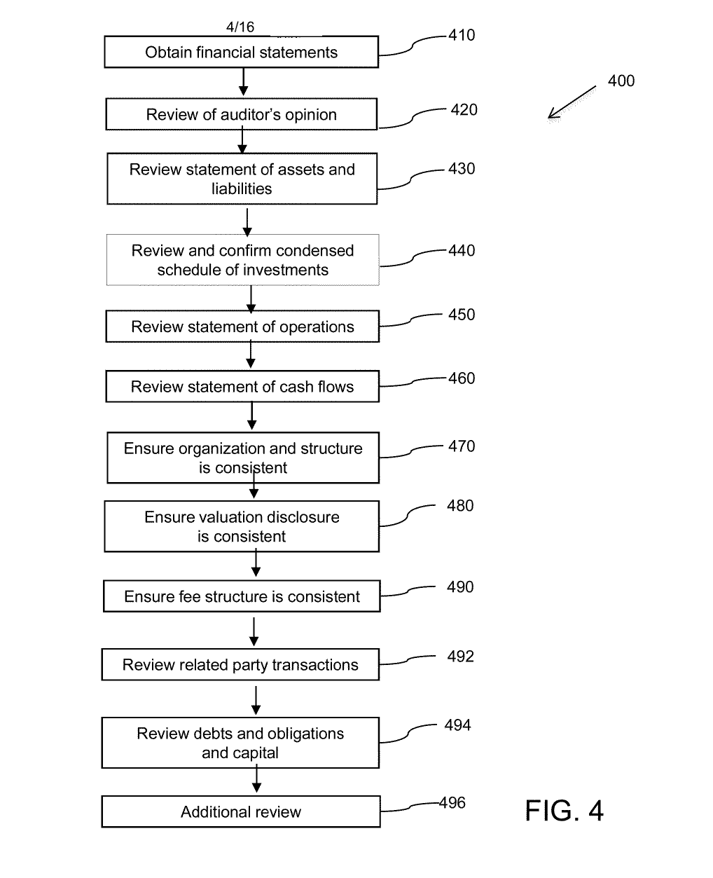

FIGS. 4-13 illustrate flow diagrams of computer-implemented processes according to some embodiments. These embodiments may be utilized for conducting due diligence review of one or more hedge fund entities. Different categories of information and review are discussed below, these categories may be weighted equally, or differential weighting may be employed to emphasize a particular area or areas of the entity or fund. Such reviews may be conducted at an initial stage to review one or more hedge fund entities for investment as well as a post investment stage to re-validate or re-certify one or more fund entities. Various elements of system architecture 300 may execute processes according to some embodiments. Processes may be embodied within program instructions of data management system shown in FIGS. 1-2, but embodiments are not limited thereto. Processes mentioned herein may be embodied in processor-executable program instructions read from one or more computer-readable media, such as a floppy disk, a CD-ROM, a DVD-ROM, a Zip™ disk, and a magnetic tape, and then stored in a compressed, uncompiled and/or encrypted format. In some embodiments, hard-wired circuitry may be used in place of, or in combination with, program instructions for implementation of processes according to some embodiments. Embodiments are therefore not limited to any specific combination of hardware and software.

In an embodiment shown in FIG. 4, auditing a hedge fund entity may include review of the hedge fund's financial profile using method 400. Method 400 may begin by obtaining the most recent 3 years audited financial statements and confirm that the statements were prepared in accordance with acceptable accounting standards, such as U.S. Generally Accepted Accounting Principles (GAAP), and/or International Financial Reporting Standards (IFRS), and that those financial statements are audited by a reputable auditing firm (Note: In a master/feeder structure, obtain audited financials for BOTH the feeder fund and the master fund) at step 410. Method 400 continues by reading the auditor's opinion and confirming that the opinion does not contain any qualifications or cautionary or unusual statements at step 420. Method 400 continues with reviewing the Statement of Assets and Liabilities; confirming and commenting on whether the nature of assets, liabilities and capital are consistent with knowledge of the fund and the manager's representations at step 430. Method 400 continues with reviewing the condensed schedule of investments; confirming and commenting on whether the types of investments held are consistent with an understanding of the investment strategy and exposures of the fund at step 440. Method 400 continues with reviewing the Statement of Operations; confirming and commenting on whether the income and expenses of the fund are consistent with the reviewer's knowledge of the fund's activities and the manager's representations at step 450. Method 400 continues with reviewing the statement of cash flows for any unusual items at step 460. Method 400 continues with ensuring and commenting on whether the organization of the fund and master/feeder structure (if applicable) is consistent with the reviewer's understanding at step 470. Method 400 continues with ensuring and commenting on whether the valuation disclosure is consistent with the valuation reviewed in the valuation section at step 480. Method 400 further continues with ensuring and commenting on whether fee structure is consistent with the reviewer's understanding and the manager's representations at step 490. Method 400 continues with reviewing and commenting on any related party transactions for potential conflicts of interests at step 492. Method 400 continues with reviewing for and commenting on any disclosures of borrowings, liabilities or other existing or contingent obligations of the fund and ensuring/commenting on whether terms of the fund's capital are consistent with the reviewer's understanding and the manager's representations at step 494. Method 400 continues with additional review such as reviewing for and commenting on the financial highlights footnote and related expense ratios to corroborate performance and expense information obtained from the manager and reviewing for and commenting on subsequent events for any material items, such as significant redemptions, contracts, etc, at step 496.

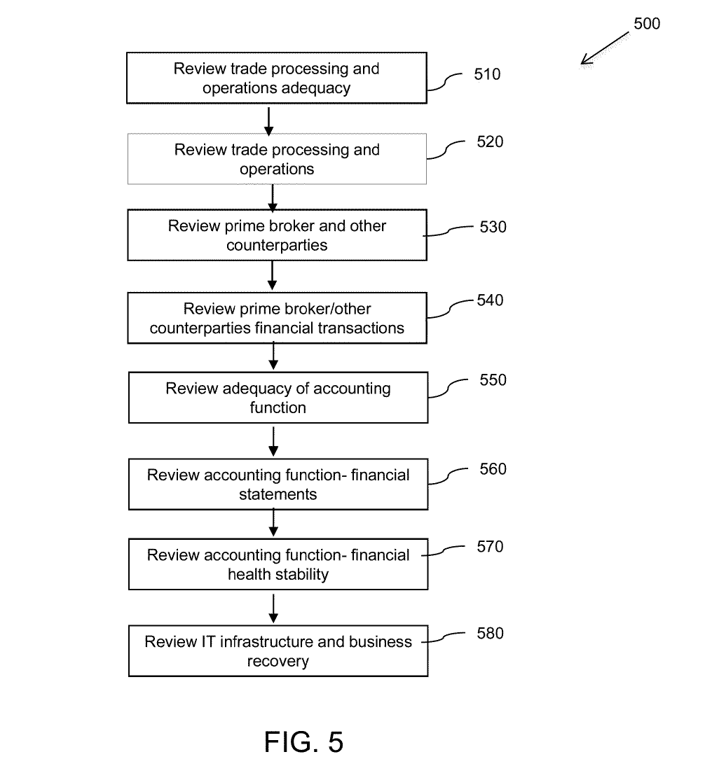

The method 500 depicted in FIG. 5 may be utilized to conduct operations and business risk management review. Such a review may include a review of trade processing and operations adequacy at step 510. Review at step 510 may include the steps to obtain an understanding of the organizational structure of the back and middle office, systems used and service providers; discuss trade processing and controls with key Operations personnel; assess independence of the operations department from the front-office; confirm that the manager's back and middle office have sufficient resources to manage expected trading and transaction volumes; confirm that the manager's back and middle office have sufficient resources to manage expected trading and transaction volumes, and understand and evaluate the manager's written trade error policy to determine if it assigns financial responsibility for errors appropriately.

Method 500 may also include a step to review trade processing and operation including complex transactions at step 520. Such a review may include steps to inquire about OTC derivatives and other complex financial instruments to determine the portion of the fund that is invested in such instruments; identify the systems used to process and price such instruments.

Method 500 may also include a step to conduct a review of prime broker/other counterparties at step 530. Such review at step 530 may include sub-steps to discuss with appropriate operational personnel; ensure that manager selects prime brokers with adequate liquidity, that counterparty credit risk is otherwise managed appropriately, and that prime brokers and other important trading counterparties have the ability to perform their duties effectively; ensure manager has procedures in place to monitor the stability of prime brokers and other counterparties; evaluate whether the fund's counterparty and financing arrangements have been appropriately stress-tested to understand the circumstances in which a trading relationship can be unwound or marginal collateral requirements increased.

Method 500 may also include a step to prime broker/other counterparties-financial transactions at step 540. Such a step 540 may include sub-steps to ensure appropriate policies and procedures are in place to govern financing arrangements (i.e. International Swaps and Derivatives Association, Inc. (ISDA) agreements, collateral procedures, margin arrangements, etc.); and inquire about the existence/use of term financing and other borrowings.

Method 500 may also include a step to measure accounting function-adequacy at step 550. Such a measurement at step 550 may include sub-steps to obtain an understanding of the organizational structure of the accounting finance department, systems used and service providers; discuss processes and controls around recording keeping, Net Asset Value (NAV) calculation and financial statement preparation; assess independence of the accounting/finance department from the front-office.

Method 500 may also include a step to measure accounting function-financial statements at step 560. Such a measurement at step 560 may include steps to confirm that the manager continues to provide audited GAAP financial statements on an annual basis; discuss financial statement preparation and role of auditor and question about auditor; request copy of a management letter received from auditor; inquire about any material control weaknesses identified during the audit(s); inquire whether there has been any disagreement with the auditor.

Method 500 may also include a step to measure accounting function-financial health/stability at step 570. Such a measurement at step 570 may include steps to obtain understanding of how the manager is capitalized; inquire about any debt outstanding or other material liabilities at the management company; inquire about the financial statement process for the management company.

Method 500 may also include a step to review IT infrastructure and business recovery at step 580. The review at step 580 may include a review/discuss business continuity plan with key operational/IT personnel.

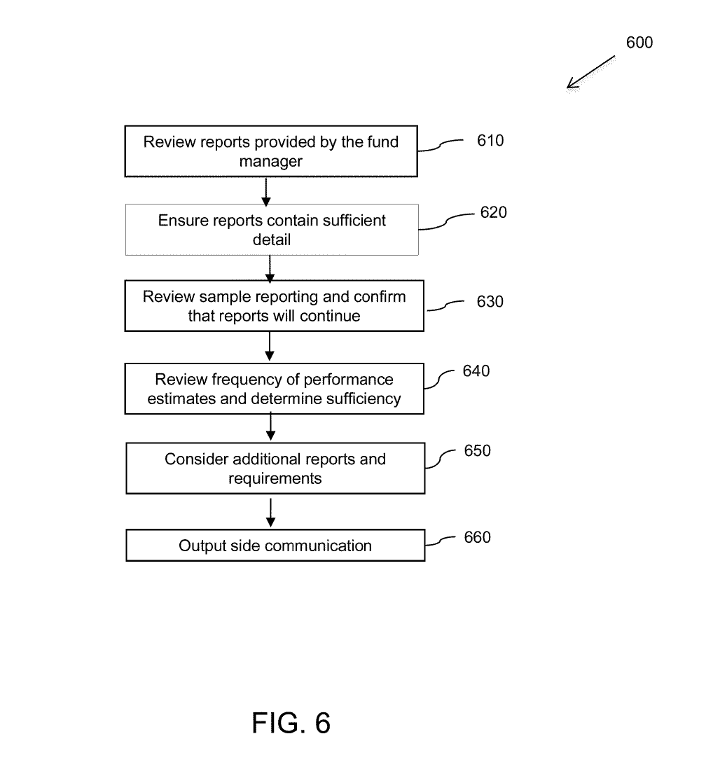

In an embodiment shown in FIG. 6, a method 600 for review of the fund entity's reporting and transparency may be conducted by the system 300. Method 600 may include obtaining an understanding of the reports provided by the manager on a consistent basis at step 610. Method 600 may ensure the reports contain sufficient detail about the fund including general asset classes to which the portfolio is allocated and sufficient details about the individual holdings to allow the investor to evaluate the associated risk exposures, such as the types of securities the fund holds, broken down by sector, duration, credit quality, geographic region, exposures related to derivative positions, etc., at step 620. Method 600 may include review sample reporting, including risk reports, and confirm that the firm will continue providing these reports at step 630. Method 600 may include an inquiry about the frequency of performance estimates provided by the manager (i.e. daily, weekly, monthly) and a determination whether such frequency is sufficient at step 640. Method 600 may include considering adding certain reports and/or reporting requirements at step 650. Method 600 may include outputting a side communication such as a side letter at step 660.

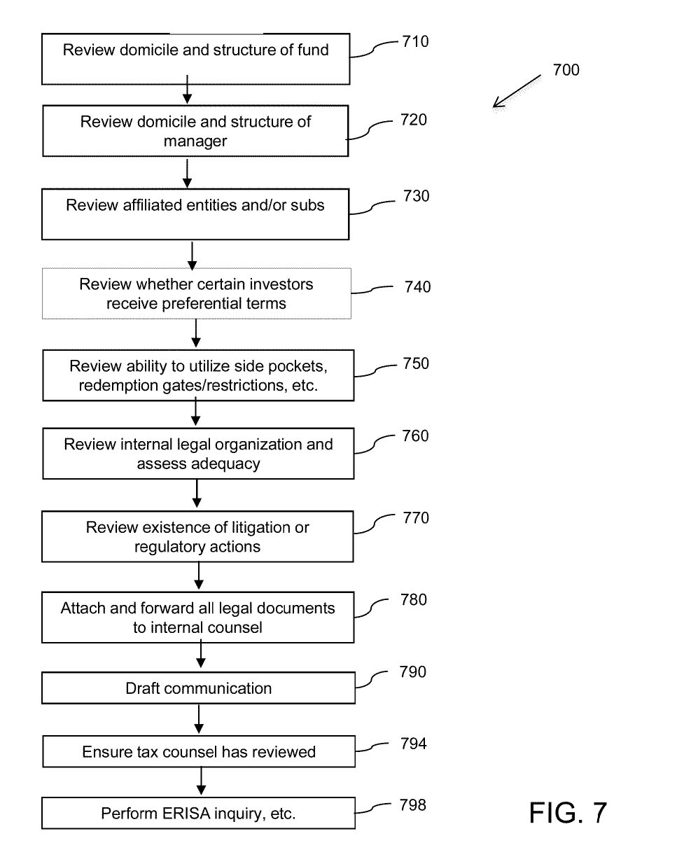

In an embodiment illustrated in FIG. 7, a method 700 is shown for reviewing the fund entity's legal structure is conducted by the system. Method 700 may begin by reviewing and understanding the domicile and legal structure of the fund including its capital structure at step 710. Method 700 may include reviewing and understanding the domicile and legal structure of the manager and its relationship to the fund at step 720. Method 700 may include inquiring and reviewing affiliated entities or subsidiaries of either the fund or the manager at step 730. Method 700 may include inquiring and reviewing whether certain investors receive preferential terms and, if so, what those preferential terms are at step 740. Method 700 may include reviewing and inquiring about the ability to utilize side pockets, redemption gates/restrictions or other such provisions at step 750. Method 700 may include reviewing and obtaining an understanding of the internal legal organization and assess adequacy given the complexity, size, structure etc. of the hedge fund and its investment activities at step 760. Method 700 may include reviewing and inquiring about the existence (historical and present) of any actual or pending litigation or regulatory actions at step 770. Method 700 may include attaching and forwarding all legal documents to internal counsel, including: OM, Articles of Incorporation or Partnership Agreement, and Subscription Documents at step 780. Method 700 may include drafting a communication such as a side letter addressing points of interest to the reviewing entity at step 790. Method 700 may include ensuring tax counsel has reviewed the legal documents for related tax items and considerations at step 794. Method 700 may include performing an Employee Retirement Income Security Act (ERISA) based inquiry which may include inquiring about ERISA capacity in the fund and determine whether the fund is a “plan asset fund” (e.g. the fund is considered a “plan asset fund” if ERISA interest in the fund are greater than 25% of outstanding interests) at step 798. If the Fund is a “plan asset fund,” it is determined if the hedge fund manager is an ERISA fiduciary and complies with the requirements for an ERISA fiduciary, including whether they have elected to be a Qualified Professional Asset Manager (QPAM) and currently satisfy the requirements of a QPAM; determining if the hedge fund manager is an ERISA fiduciary and complies with the requirements for an ERISA fiduciary, including the QPAM requirements, where applicable; assessing whether the hedge fund manager provides assurances that it will assume fiduciary duties including loyalty and due care provided by ERISA, and if not, whether the investment is appropriate; and confirming that the manager will provide HIMCO with notice if the manager ceases to qualify as a QPAM.

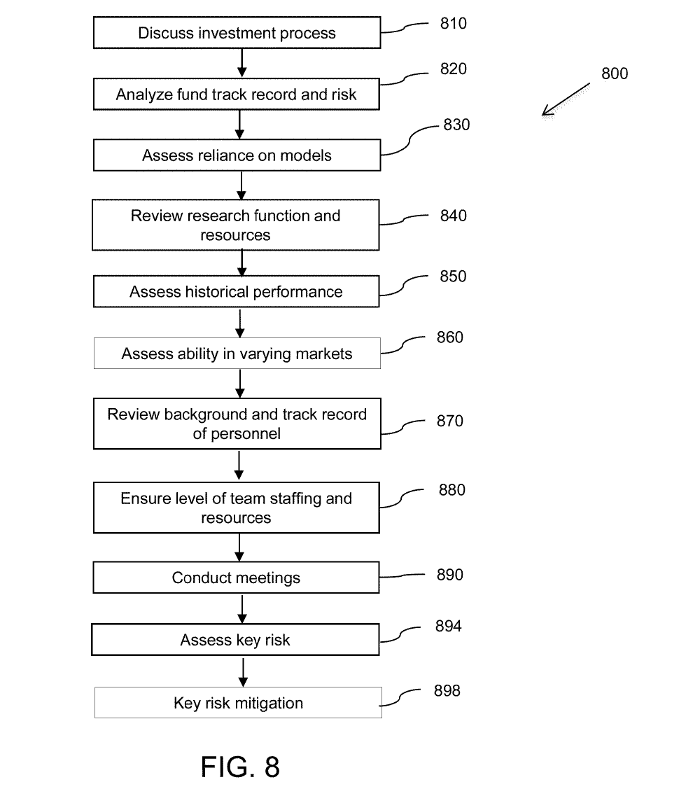

In an embodiment illustrated in FIG. 8, a method 800 for reviewing the fund entity's investment process is conducted by system 300. Method 800 may include discussing the investment process with investment personnel at step 810. Method 800 may include analyzing the fund's track record and risk exposures as a means of evaluating potential style drift and anomalies at step 820. Method 800 may include assessing the hedge fund manager's reliance on models, including assumptions, model inputs, and risks associated with the models the manager employs at step 830. Method 800 may include obtaining an understanding of research function and resources relied upon for investment research at step 840. Method 800 may include assessing the manager's historical performance and the factors contributing to that performance at step 850. Method 800 may include assessing the manager's ability to operate a fund successfully in varying market environments at step 860. Method 800 may include examining the background and track record of key investment personnel at step 870. Method 800 may include ensuring the investment team(s) is appropriately staffed and resourced at step 880. Method 800 may include conducting face-to-face meetings with key investment personnel at step 890. Method 800 may include assessing “key man” risk at step 894. Method 800 may include ensuring any material “key man” risk is mitigate via the offering documents or in a side letter agreement at step 898.

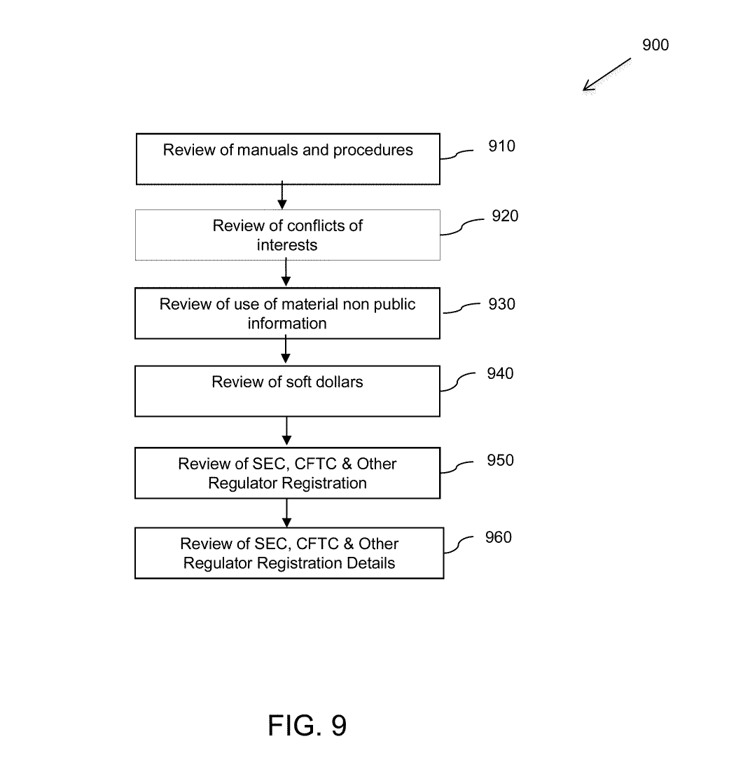

In an embodiment illustrated in FIG. 9, a method 900 is shown for a review of fund compliance is performed with respect to one or more fund entities. Method 900 may include a review of manuals and procedures at step 910, a review of conflicts of interests at step 920, a review of use of material nonpublic information at step 930, a review of soft dollars at step 940, a review of SEC, Commodity Futures Trading Commission (CFTC) and other regulator registration at step 950 and a review of SEC, CFTC and other regulator registration details at step 960. The review of manuals and procedures at step 910 may include obtaining an understanding of the compliance functions and their role within the organization. Step 910 continues with a discussion of the compliance program, policies and procedures with the Chief Compliance Officer and ensures an effective program is in place. (Specific policies to discuss include personal trading, MNPI, soft dollars, conflicts of interest and trade allocation.) Step 910 continues with a step to comment on the compliance manual, or sections thereof, to ensure sufficient written policies are in place (e.g., COE, Personal Trading, Material Non Public Information (MNPI), Soft Dollars, Conflicts of Interest, Trade Allocation). Step 910 continues with a step to Obtain, review and comment on Form ADV Part 2 with particular focus on conflicts of interest, trade allocation practices, personal trading policies/practices and soft dollar arrangements.

A review of the conflicts of interest at step 920 may include a step to discuss the list of potential conflicts of interest with the CCO. Step 920 continues with a step to inquire about the existence of affiliated entities or outside business activities. Step 920 continues with a step to review ADV part 2 for information on conflicts of interest. Step 920 continues with a step to confirm that the manager has appropriate conflict-of-interest procedures and controls in place to provide for the fair and equitable allocation of investment opportunities across different accounts.

The review of the use of material non-public information at step 930 may include a step to discuss with the CCO the compliance policies and procedures in place to mitigate the risk of improper handling or use of MNPI. Step 930 continues with a step to inquire about the use of external data providers, research consultants, vendors or expert networks. If such sources are used, system 300 may understand the approval and monitoring process for using data providers, vendors, research consultants, etc. Step 930 may continue with a step to inquire as to whether the firm or any employee of the firms has received a request or been investigated by regulators regarding MNPI. Step 930 may continue with a step to review and discuss the firm's personal account trading policy.

The review of soft dollars at step 940 may include a step to discuss the policies governing the use of soft dollars with the CCO. Step 940 may continue with a step to Inquire specifically about the use of soft dollars for any products/services outside the scope of the 28(e) safe harbor. Step 940 may continue with a step to discuss procedures in place to approve and monitor use and payment of soft dollars. Step 940 may continue with a step to review ADV part 2 for information and disclosures on use of soft dollars.

The review of SEC, CFTC and other regulator registration at step 950 may include a step to inquire about registrations, licenses, etc. the firm holds with regulatory bodies and the dates of such registrations. Step 950 may continue with a step to independently confirm and provide details of the manager's SEC registration and if it is still valid via the SEC website.

The review of SEC, CFTC and other regulator registration details at step 960 may include a step to inquire about the nature and results of any correspondence received from regulators (including SEC, IRS, CFTC, etc.). Step 960 may continue with a step to inquire about the nature and results of any SEC exams both past and present (inquire about any deficiency letters). Step 960 may continue with a step to Inquire whether there has been any breach of the rules of any regulatory body of which the firm or fund is registered/licensed with. Step 960 may continue with a step to inquire whether there are any existing investigations current being undertaken by any regulatory body in respect of the firm or fund or any of its employees or affiliates.

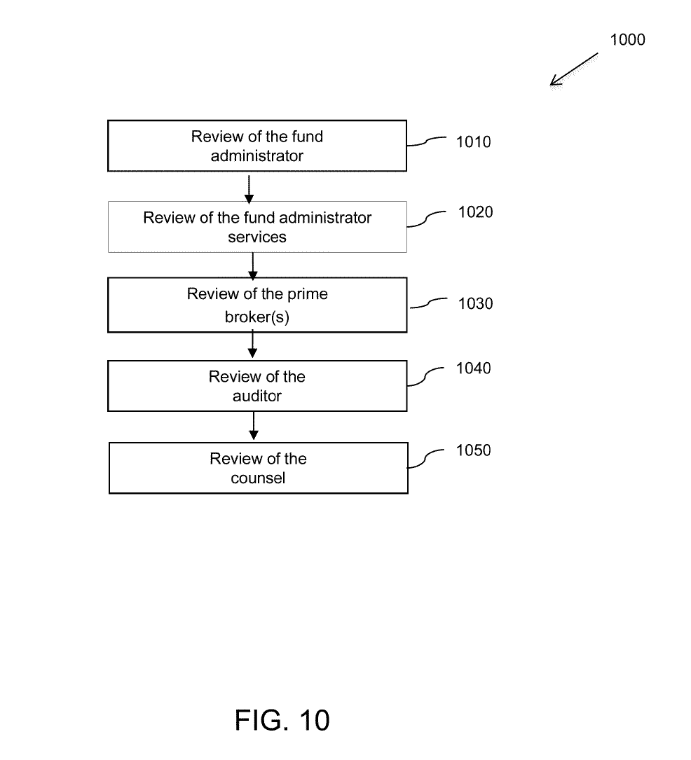

A review of third party services associated with one or more funds is illustrated in FIG. 10 as method 1000. Method 1000 may include a step 1010 to assess the reputation of the Administrator within the industry. Step 1010 may include a measure of the adequacy of the Administrator with hedge fund personnel. Step 1010 may include a step to confirm longevity of relationship with the Administrator and assess reasons for any change in administrators. Step 1010 may include a step to inquire whether there have been any problems/difficulties relating to fund administration. Step 1010 may include a step to obtain an understanding of the process used by the manager to monitor the Administrator. Step 1010 may include a step to request and review the administrators SAE 16, if applicable.

Method 1000 may include a review of fund administrator-services at step 1020. Step 1020 may include a step to discuss the nature and scope of services provided with hedge fund personnel. Step 1020 may include a step to confirm the information gathered in the previous procedure directly with the Administrator. Step 1020 may include a step to assess any weaknesses or gaps in the services provided. Step 1020 may include a step to confirm that the Administrator is independent from the manager. Step 1020 may include a step to confirm the most recent AUM of the fund directly with the Administrator.

Method 1000 may include a review of the prime broker(s) at step 1030. Step 1030 may include a step to assess the reputation of the fund's prime broker(s) within the industry. Step 1030 may include a step to discuss the adequacy of the prime broker(s) with hedge fund personnel. Step 1030 may include a step to confirm longevity of relationship with the prime broker(s) and assess reasons for any change in prime broker(s). Step 1030 may include a step to inquire whether there have been any problems/difficulties relating to fund brokerage activities. Step 1030 may include a step to confirm relationship and fund assets directly with prime broker(s). Step 1030 may include a step to confirm that prime broker(s) is independent from the manager.

Method 1000 may include conducting a review of the third party auditor at step 1040. Step 1040 may include a step to assess the reputation of the Auditor within the industry. Step 1040 may include a step to discuss the adequacy of the Auditor with hedge fund personnel. Step 1040 may include a step to confirm longevity of relationship with the Auditor and assess reasons for any change in auditors. Step 1040 may include a step to inquire whether there have been any problems/difficulties/disagreements with the auditor.

A review of the counsel may also be conducted at step 1050. Step 1050 may include a step to assess the reputation of external counsel within the industry. Step 1050 may include a step to discuss the adequacy of external counsel with hedge fund personnel. Step 1050 may include a step to confirm longevity of relationship with external counsel and assess reasons for any change in counsel. Step 1050 may include a step to inquire whether there have been any problems/difficulties relating to legal matters.

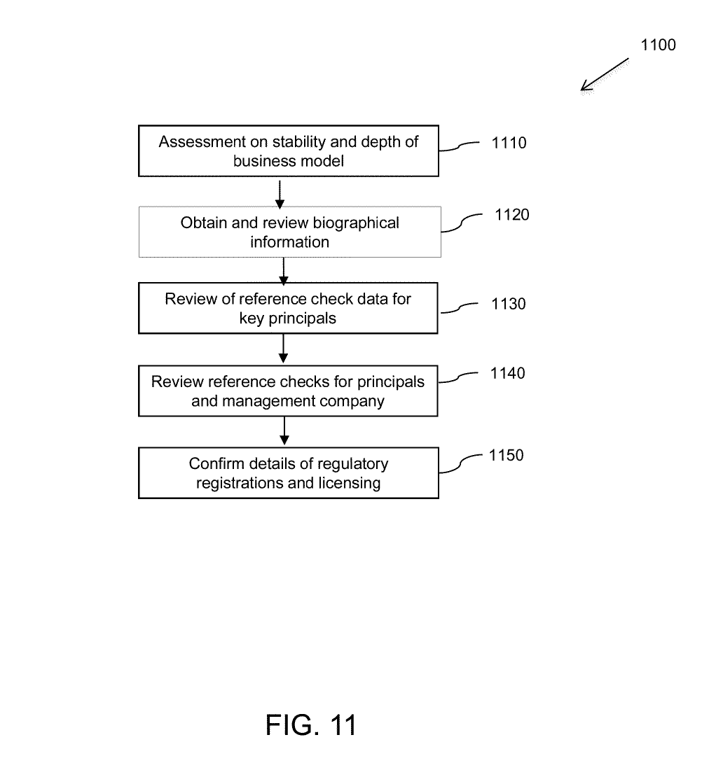

Referring now to FIG. 11, there is shown a method 1100 for reviewing a fund's general organization. Method 1100 may include a qualitative assessment and comment on the stability and depth of the manager's business at step 1110. This assessment may be performed by considering the following factors: History of the business, Organizational legal structures, AUM and performance, Client base, Organizational department structure, Adequacy of staffing level and resources and the organization quality and depth. Method 1100 may include obtaining, reviewing and commenting on biographies of all key investment and operational personnel at step 1120. Method 1100 may include performing and commenting on personal and professional reference checks for key principals at step 1130. Method 1100 may include performing and commenting on background checks for key principals and the management company at step 1140. Method 1100 may include confirming and providing details of the status of regulatory registrations and licensing at step 1150.

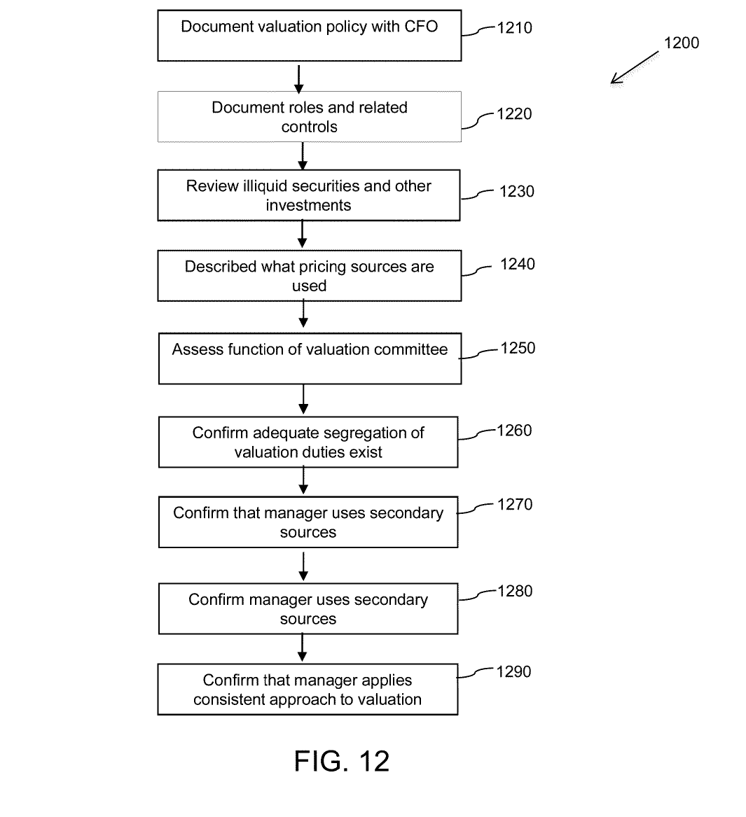

Referring now to FIG. 12, there is shown a method 1200 for reviewing the funds' valuation policy. Method 1200 may include a step to document the valuation policy based on discussions with the CFO at step 1210. Method 1200 may include a step to document roles and related controls around valuation based on discussions with the CFO at step 1220. Method 1200 may include a step to inquire and document details specifically about illiquid securities or other investments that are difficult to price at step 1230. Method 1200 may include a step to describe what pricing sources are used, including independent pricing sources at step 1240. Method 1200 may include a step to assess the functioning of the valuation committee or other governance structure of the hedge fund, and evaluate whether there is sufficient oversight of the valuation process, including a mechanism to resolve conflicts relative to pricing on difficult to price investments at step 1250. Method 1200 may include a step to confirm that adequate segregation of valuation duties exists, and that valuation functions are performed by suitably independent, competent, and experienced professionals at step 1260. Method 1200 may include a step to confirm that the manager uses secondary sources whenever possible to enhance the reasonableness of pricing and valuation estimates at step 1270. Method 1200 may include a step to confirm that the manager uses multiple sources for dealer quotes where they are available and any models the manager uses to determine position prices are independently tested and verified at step 1280. Method 1200 may include a step to confirm that the manager applies a consistent approach to valuing “side-pocket” or illiquid/hard-to-value positions at step 1290.

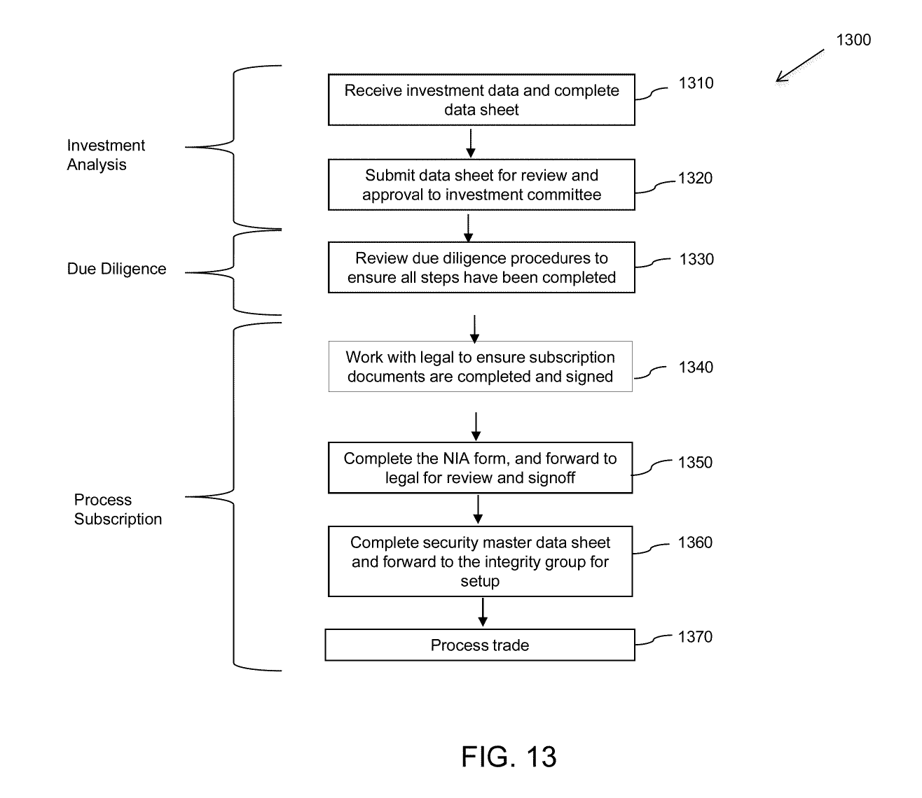

FIG. 13 illustrates a method 1300 that may be utilized to perform a review approval and subscription for one or more selected funds. Method 1300 may include a step to receive investment data and complete the data sheet at step 1310. Method 1300 may include a step to submit the investment write-up to the Investment Committee for review and approval at step 1320. Method 1300 may include a review the due diligence procedures to ensure all steps have been completed to satisfaction at step 1330. Method 1300 may include a step to work with legal to ensure the subscription documents are completed and signed at step 1340. Method 1300 may include a step to complete the NIA form, print and forward to legal for review and signoff at step 1350. Method 1300 may include a step to complete the security master data sheet and forward to the integrity group for setup at step 1360. Method 1300 may include a step to process a trade at step 1370.

Method 1300 may be categorized into groups of steps as shown in FIG. 13. Steps 1310 and 1320 may be grouped as investment analysis. Step 1330 may comprise due diligence. Steps 1340, 1350, 1360, 1370 may be grouped as process subscription.

The present description describes a number of methods where review takes place. This review may be performed by a single reviewer, or the review may be performed by any number of different reviewers. In addition, each of the respective review steps may also include an approval by an approver. This approver may be one of the potentially many reviewers, may be all or some of the reviewers, or may be an entity that is different from the reviewer or reviewers. Additionally, the approver may be required to be different from the reviewer.

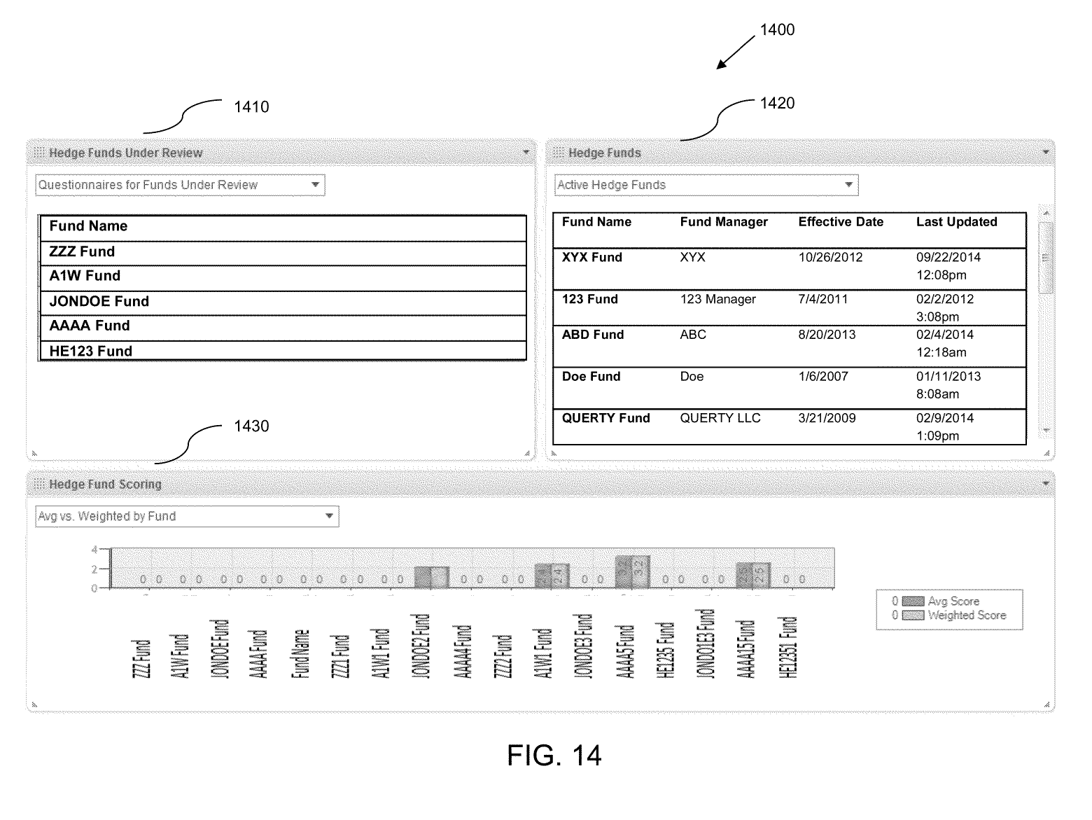

Reference is now made to FIG. 14 which is a tabular representation of a portion of a hedge fund database record 1400. Hedge fund database record 1400 includes a number of data fields representing data associated with one or more hedge funds. Only several fields such as 1410, 1420 and 1430 are identified for each record for convenience and ease of exposition—those skilled in the art will appreciate that a typical record may have more fields and data elements. Some or all of the data populating hedge fund database record 1400 may be obtained or generated during a due diligence process. Embodiments are not limited to the fields shown in FIG. 14, and each data field need not be populated in some embodiments. Database record 1400 may also be tagged, relational or linked. Database record 1400 may be used to select and invest in one or more hedge funds as described herein. Field 1410 may illustrate hedge funds under review. Field 1420 may illustrate hedge funds within the system. Field 1430 may illustrate hedge fund scoring.

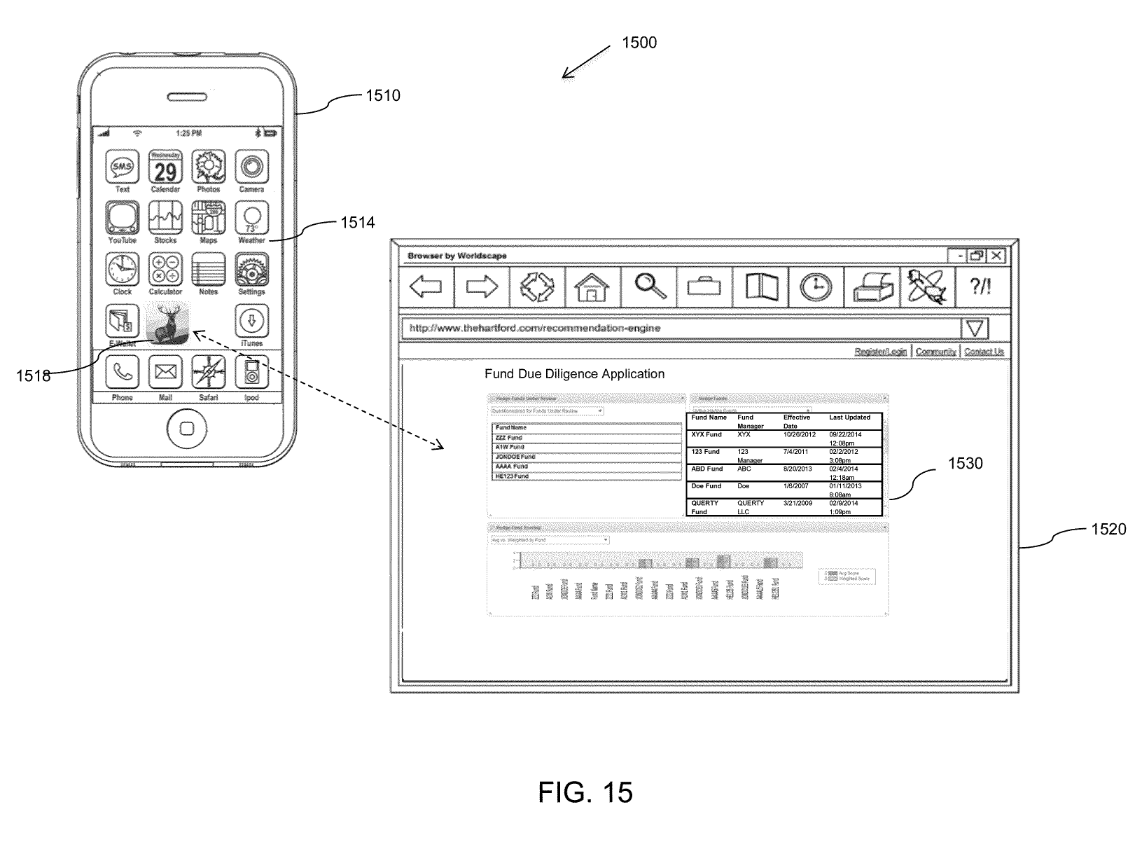

FIG. 15 illustrates an example depiction 1500 including a user device 1510 accessing a user interface 1514 for the review and administration of hedge fund data. User interface 1514 may be an application type screen that provides access to an insurance company application such as an application provided by The Hartford. As shown, The Hartford application 1518 is configured to provide a user interface 1520 that may display an application form 1530 for hedge fund administration and review. Application form 1530 may request and be provided hedge fund data. User interface 1520 may also be configured to display options that have been identified (e.g., by the system 100). Those skilled in the art will appreciate that a wide variety and type of user interfaces may be provided, and that the depiction 1500 is provided for illustrative purposes only.

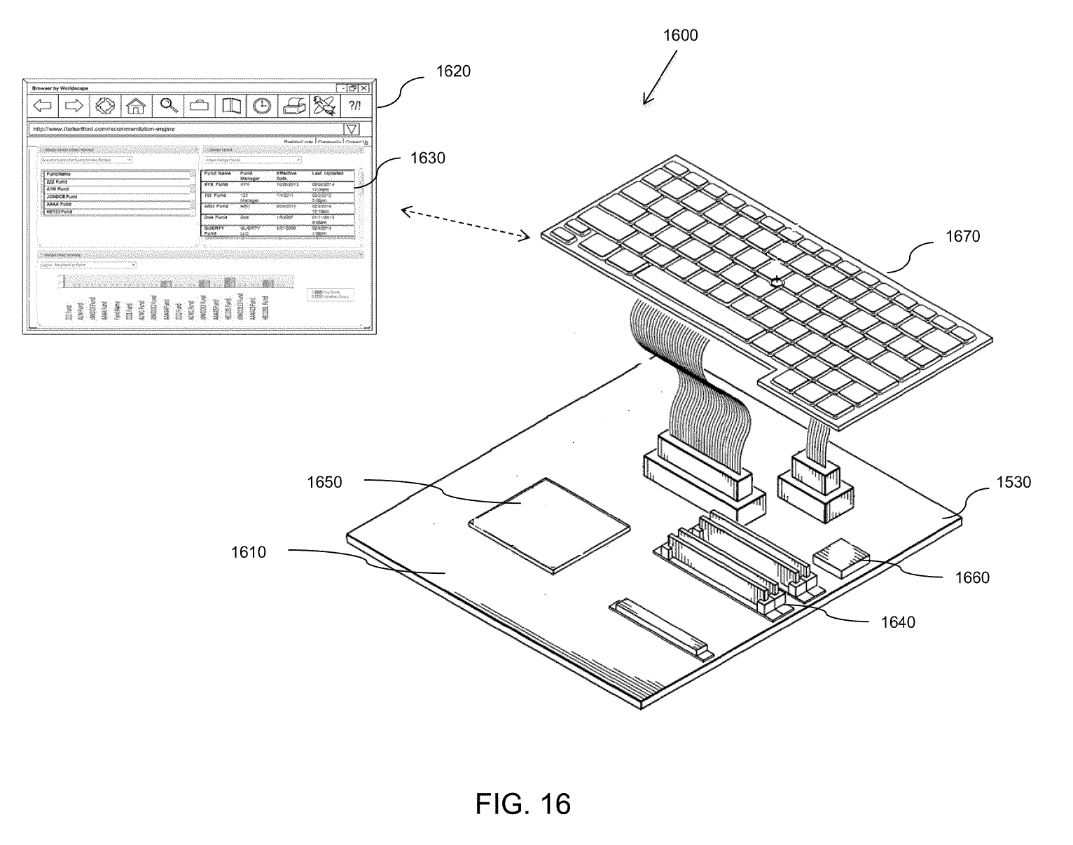

FIG. 16 illustrates a system 1600 including a user device 1610 for enabling and accessing a hedge fund management system interface 1620 for the review and administration of hedge fund data. System interface 1620 may be an application type screen 1630 that provides access to an insurance company application such as an application provided by The Hartford. Those skilled in the art will appreciate that a wide variety and type of user interfaces may be provided, and that the depiction 1630 is provided for illustrative purposes only. User device 1610 may be a specialized computer in communication with a network storage device, or any other suitable device and may vary in size, shape, performance, functionality, configurability and form. Device 1610 may include random access memory (RAM) 1640, one or more processing resources such as a central processing unit (CPU) 1650 or hardware or software control logic, ROM, and/or other types of memory. Additional components of device 1610 may include one or more network ports 1660 for communicating with external devices as well as various input and output (I/O) devices, such as a keyboard 1670 or other input type device. Device 1610 may also include one or more buses operable to transmit communications between the various hardware components.

The embodiments described herein are solely for the purpose of illustration. Those in the art will recognize that other embodiments may be practiced with modifications and alterations limited only by the claims. For example, though the methods and features described above with reference to FIGS. 1-16 are described above as performed using the example architecture 100 of FIG. 1 and the exemplary system 200 of FIG. 2, the methods and features described above may be performed using any appropriate architecture and/or computing environment. Although features and elements are described above in particular combinations, each feature or element can be used alone or in any combination with or without the other features and elements. For example, each feature or element as described with reference to FIGS. 1-16 may be used alone without the other features and elements or in various combinations with or without other features and elements. Sub-elements of the methods and features described above with reference to FIGS. 1-16 may be performed in any arbitrary order (including concurrently), in any combination or sub-combination.

What is claimed is:

1. A database system in a distributed client server network environment for matching prospect data with structured query data, the system comprising:
a communications interface;
a memory coupled to the communications interface, the memory configured to store an electronic query processing application; and
a processor in communication with the memory, the processor being configured to execute the electronic query processing application stored in the memory, the electronic query processing application comprising program instructions for:
compiling an electronic document containing structured queries for one or more fund entities;
communicating the structured queries to the one or more fund entities;
receiving data in response to the structured queries from the one or more fund entities;
augmenting a content of the electronic document with the received data;
parsing the electronic document in view of a plurality of baseline data;
informing one or more trade instructions based on the parsed document;
revalidating the received data on a periodic basis with the one or more fund entities; and
displaying a graphical user interface of the received data.

2. The database system of claim 1, wherein the structured queries relate to a fee structure of the one or more fund entities.

3. The database system of claim 1, wherein the communications interface transmits the received data to a reporting module.

4. The database system of claim 1, the structured queries relate to a reporting frequency and sufficiency of the one or more fund entities and compliance control data of the one or more fund entities.

5. The database system of claim 1, the structured queries relate to historical performance of the one or more fund entities.

6. The database system of claim 1, the structured queries relate to model inputs and model risk data of the one or more fund entities.

7. The database system of claim 1, the structured queries relate to liquidity risk data of the one or more fund entities.

8. The database system of claim 1, the structured queries relate to inputs and outputs of risk systems of the one or more fund entities.

9. The database system of claim 8, wherein the structured queries are communicated via an interactive web form to the one or more fund entities.

10. The database system of claim 1, wherein displaying a graphical user interface of the received data comprises providing a display of active and inactive fund entities.

11. The database system of claim 1, wherein displaying a graphical user interface of the received data comprises rendering a dynamic navigation menu structure containing a plurality of profile, valuation, compliance and due diligence data.

12. The database system of claim 11, wherein displaying a graphical user interface of the received data comprises providing a plurality of data filtering and sorting options.

13. A database system in a distributed network environment for matching fund prospect data with structured query diligence data, the system comprising:
a memory configured to store an electronic query processing application;
a processor in communication with the memory, the processor being configured to execute the electronic query processing application stored in the memory, the electronic query processing application comprising program instructions for:
compiling an electronic document containing structured queries for one or more fund entities;
communicating the structured queries to the one or more fund entities;
receiving data in response to the structured queries from the one or more fund entities;
augmenting a content of the electronic document with the received data;
parsing the electronic document in view of a plurality of baseline data;
compiling one or more trade instructions based on the parsed document;
informing one or more trade instructions based on the parsed document; and
revalidating the received data on a periodic basis with the one or more fund entities, wherein revalidating comprises a verification of one or more of the received data.

14. The database system of claim 13, further comprising rendering a graphical user interface of active and inactive fund entity data.

15. The database system of claim 13, further comprising a communications interface for transmitting data to a reporting module.

16. The database system of claim 13, wherein the structured queries relate to compliance control data of the one or more fund entities and historical performance of the one or more fund entities.

17. The database system of claim 16, the structured queries relate to liquidity risk data of the one or more fund entities and inputs and outputs of risk systems of the one or more fund entities.

18. A computer implemented method of operating a computer system to process fund and compliance data, the computer implemented method comprising:
compiling an electronic document containing structured queries for one or more fund entities;
communicating the structured queries to the one or more fund entities;
receiving data in response to the structured queries from the one or more fund entities;
augmenting a content of the electronic document with the received data;
parsing the electronic document in view of a plurality of baseline data;
compiling one or more trade instructions based on the parsed document;
informing one or more trade instructions based on the parsed document; and
revalidating the received data on a periodic basis with the one or more fund entities, wherein revalidating comprises a verification of one or more of the received data.

19. The computer implemented method of claim 18, wherein revalidating the received data comprising transmitting one more structured queries through a mobile device.

20. The computer implemented method of claim 18, augmenting a content of the electronic document comprises updating one or more data fields in the electronic document with the received data.
